(19) United States
(12) Patent Application Publication
(10) Pub. No.: US 2022/0071273 A1
(43) Pub. Date: Mar. 10, 2022

(54) A Vapour Generating Article, A Method For Manufacturing The Same, And A Vapour Generating System

(71) Applicant: JT International S.A., Geneva (CH)

(72) Inventor: Aleksandr Kontarev, Trier (DE)

(73) Assignee: JT International S.A., Geneva (CH)

(21) Appl. No.: 17/422,344

(22) PCT Filed: Feb. 18, 2020
(86) PCT No.: PCT/EP2020/054177

§ 371 Date: Jul. 12, 2021

(30) Foreign Application Priority Data
Feb. 21, 2019 (EP) 19158423.4
Jun. 6, 2019 (EP) 19178727.4

(51) Int. Cl. A24C 5/01; A24C 5/18; A24F 40/465; A24F 40/20; A24F 40/70

(52) U.S. Cl. CPC A24C 5/01; A24C 5/1864; A24F 40/70; A24F 40/20; A24F 40/465

(57) ABSTRACT

A method for manufacturing a vapour generating article includes: (i) extruding a plurality of elongate vapour generating components; (ii) aligning the plurality of extruded vapour generating components; (iii) assembling the plurality of aligned vapour generating components to form a band; (iv) binding the band of assembled vapour generating components; (v) cutting the bound band of assembled vapour generating components to form the vapour generating article; (vi) after step (i), drying the plurality of vapour generating components. A vapour generating article and a vapour generating system are also disclosed.

### TECHNICAL FIELD

The present disclosure relates generally to vapour generating articles, and more particularly to vapour generating articles for use with a heating device for heating the vapour generating articles to generate a vapour that cools and condenses to form an aerosol for inhalation by a user. Embodiments of the present disclosure relate in particular to a method for manufacturing a vapour generating article and/or to a vapour generating system and/or to a vapour generating article.

### TECHNICAL BACKGROUND

Devices which heat, rather than burn, a vapour generating material to produce a vapour and/or aerosol for inhalation have become popular with consumers in recent years. Such devices can use one of a number of different approaches to provide heat to the vapour generating material.

One approach is to provide a vapour generating device which employs a resistive heating system. In such a device, a resistive heating element is provided to heat the vapour generating material and a vapour or aerosol is generated as the vapour generating material is heated by heat transferred from the heating element.

Another approach is to provide a vapour generating device which employs an induction heating system. In such a device, an induction coil is provided with the device and a susceptor is provided typically with the vapour generating material. Electrical energy is provided to the induction coil when a user activates the device which in turn generates an alternating electromagnetic field. The susceptor couples with the electromagnetic field and generates heat which is transferred, for example by conduction, to the vapour generating material and a vapour or aerosol is generated as the vapour generating material is heated.

Whichever approach is used to heat the vapour generating material, it can be convenient to provide the vapour generating material in the form of a vapour generating article, e.g., which can be inserted by a user into the vapour generating device. As such, there is a need to provide a vapour generating article which can be manufactured with relative ease.

### SUMMARY OF THE DISCLOSURE

According to a first aspect of the present disclosure, there is provided a method for manufacturing a vapour generating article, the method comprising:
(i) extruding a plurality of elongate vapour generating components;
(ii) aligning the plurality of extruded vapour generating components;
(iii) assembling the plurality of aligned vapour generating components to form a band;
(iv) binding the band of assembled vapour generating components;
(v) cutting the bound band of assembled vapour generating components to form the vapour generating article;
(vi) after step (i), drying the plurality of vapour generating components.

The vapour generating article is for use with a heating device for heating the vapour generating components, without burning the vapour generating components, to volatise at least one constituent of the vapour generating components and thereby generate a heated vapour which cools and condenses to form an aerosol for inhalation by a user.

According to a second aspect of the present disclosure, there is provided a vapour generating system comprising:
a vapour generating article comprising at least five extruded elongate vapour generating components; and
a heating device for heating the vapour generating article;
wherein the vapour generating article or the heating device includes a mouthpiece.

According to a third aspect of the present disclosure, there is provided a vapour generating article comprising:
at least five extruded elongate vapour generating components that form a vapour generating substrate; and
a mouthpiece.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The method according to the first aspect of the present disclosure is particularly suitable for the mass production of vapour generating articles and allows for flexible and simplified manufacture because each of the elongate vapour generating components has a much smaller cross-sectional area than the cross-sectional area of the vapour generating article.

The vapour generating article includes a plurality of oriented gaps between the adjacent elongate vapour generating components. The gaps facilitate a uniform flow of air and vapour through the vapour generating article by providing fluid flow routes. The gaps also facilitate the insertion of a heater, for example a resistive heating element or an inductively heatable susceptor, into the vapour generating article.

The elongate vapour generating components may comprise plant derived material and in particular, may comprise tobacco. The elongate vapour generating components may, for example, comprise reconstituted tobacco including tobacco and any one or more of cellulose fibres, tobacco stalk fibres and inorganic fillers such as CaCO3. The elongate vapour generating components may comprise strips.

The elongate vapour generating components may comprise an aerosol-former such as a humectant. Examples of aerosol-formers include polyhydric alcohols and mixtures thereof such as glycerine or propylene glycol. Typically, the elongate vapour generating components may comprise an aerosol-former content of between approximately 5% and approximately 50% on a dry weight basis. In some embodiments, the elongate vapour generating components may comprise an aerosol-former content of between approximately 10% and approximately 20% on a dry weight basis, possibly between approximately 13% and approximately 17% on a dry weight basis, and possibly approximately 15% on a dry weight basis.

In some embodiments, step (i) may comprise extruding a composition to form the plurality of elongate vapour generating components, wherein the composition may comprise: tobacco in an amount between approximately 50 wt. % and approximately 80 wt. % and having a particle size between approximately 50 μm and approximately 250 μm; a binder, e.g. carboxymethyl cellulose, in an amount between approximately 1 wt. % and approximately 15 wt. %; a humectant, e.g. glycerine or propylene glycol, in an amount between approximately 10 wt. % and approximately 30 wt. %; water in an amount between approximately 2 wt. % and 20 wt. %; and a flavourant, e.g. a liquid flavourant) in an amount between approximately 2 wt. % and 8 wt. %.

The tobacco and binder constitute ingredients of the composition which are solid at room temperature and room pressure. The humectant, water and liquid flavourant constitute ingredients of the composition which are liquid at room temperature and room pressure. Step (i) may comprise mixing the solid ingredients and thereafter adding the liquid ingredients to the solid ingredients.

Step (i) may be performed at an extrusion temperature between approximately 20° C. and approximately 180° C. In some embodiments, step (i) may be performed using an extruder. The temperature within the extruder may be between approximately 20° C. and approximately 180° C. The temperature at the exit of the extruder may be between approximately 80° C. and approximately 180° C.

The extruded elongate vapour generating components typically comprise solid vapour generating components. The term “solid” is used herein to denote a vapour generating component that is not hollow and that is free from holes or cavities. Solid vapour generating components have excellent stability and are capable of retaining their form. This is to be contrasted, for example, with hollow vapour generating components, e.g. tubular vapour generating components, which may be susceptible to collapsing and/or crushing and/or breakage, for example during manufacture (e.g. winding of the vapour generating component on a bobbin) or due to handling of the vapour generating article by a user. Collapsing or crushing of the vapour generating components is undesirable as it may compromise the air flow route(s) through the vapour generating article, thus affecting aerosol delivery to the user and/or resulting in a vapour generating article with a deformed appearance.

In embodiments in which the vapour generating article includes a mouthpiece, the mouthpiece may comprise a filter, for example comprising cellulose acetate fibres.

Steps (i) and (ii) may comprise extruding a plurality of elongate vapour generating components in parallel to thereby simultaneously align the elongate vapour generating components. The manufacturing method is thereby simplified.

Step (vi) may be performed before step (iii). The individual elongate vapour generating components can be dried more easily prior to assembly during step (iii). After assembly of the elongate vapour generating components during step (iii) to form a band, the vapour generating components positioned towards the middle of the band may be more difficult to dry.

The method may further comprise after steps (i) and (vi) and prior to step (ii):
(vii) winding one of the dried elongate vapour generating components on a bobbin; and
(viii) unwinding the dried elongate vapour generating component from the bobbin.

Accordingly, steps (i) and (vi) of the method can be performed at a location which differs from a location at which the subsequent steps of the method are performed. This allows for increased flexibility of manufacture.

Step (vii) may comprise winding a predetermined length of one of the dried elongate vapour generating components onto the bobbin and cutting the dried elongate generating component after the predetermined length thereof has been wound onto the bobbin.

Step (vii) may comprise winding a plurality of the dried elongate vapour generating components onto individual bobbins and step (viii) may comprise unwinding the dried elongate vapour generating components from the individual bobbins such that, during step (ii), each of the plurality of extruded vapour generating components is supplied from one of the individual bobbins.

Step (iv) may comprise wrapping the band of vapour generating components. Step (iv) may, for example, comprise wrapping the band of vapour generating components with a sheet of material which may be air-permeable and which may be electrically insulating and non-magnetic, for example a paper wrapper.

The method may further comprise after step (iv), and preferably after step (v), inserting an inductively heatable susceptor into the plurality of bound vapour generating components. The method thus provides a particularly convenient way to manufacture inductively heatable vapour generating articles.

Step (ii) may further comprise positioning an inductively heatable susceptor having an elongate part between the plurality of elongate vapour generating components, preferably with the elongate part in alignment with the elongate vapour generating components. Such an arrangement may ensure a uniform heat transfer from the inductively heatable susceptor to the elongate vapour generating components.

Step (iii) may comprise assembling the plurality of aligned vapour generating components and the inductively heatable susceptor to form a band and step (iv) may comprise binding the band of assembled vapour generating components and the inductively heatable susceptor. The manufacture of inductively heatable vapour generating articles is thereby simplified.

The inductively heatable susceptor may comprise a continuous inductively heatable susceptor, for example a sheet or strip-shaped or plate-shaped susceptor. Step (v) may comprise cutting the bound band of assembled vapour generating components and the continuous inductively heatable susceptor to form the vapour generating article. The manufacture of inductively heatable vapour generating articles is further simplified and mass production can be achieved.

The inductively heatable susceptor may comprise a particulate susceptor material. The use of a particulate susceptor material may provide a uniform heat transfer to the elongate vapour generating components during use of the vapour generating article in a heating device.

Step (i) may comprise extruding a vapour generating component from an aperture having a cross-sectional area with a maximum dimension between 0.5 mm and 1.0 mm.

Prior to drying the elongate vapour generating components during step (vi), the elongate vapour generating components may have a moisture content, for example a water content, between approximately 15 wt. % and approximately 40 wt. %. After drying the elongate vapour generating components during step (vi), the elongate vapour generating components may have a moisture content, for example a water content, between approximately 8 wt. % and 25 wt. %.

The vapour generating article may comprise at least 10 extruded elongate vapour generating components and may comprise at least 20 extruded elongate vapour generating components. The vapour generating article may comprise up to 100 extruded elongate vapour generating components and may comprise up to 70 extruded elongate vapour generating components. The elongate vapour generating components may together form a vapour generating substrate. A greater number of elongate vapour generating components tends to result in the presence of more gaps between the vapour generating components and may, therefore, advantageously provide a more uniform airflow through the vapour generating article. An excessive number of elongate vapour generating components is, however, undesirable because it is typically necessary to reduce the cross-sectional area of the vapour generating components as the number of components increases to ensure that the vapour generating article has appropriate dimensions. If the cross-sectional area of the vapour generating components is too low, the strength of the components may be reduced and, consequently, mass production of vapour generating articles may become difficult.

The plurality of elongate vapour generating components may be substantially oriented in the same direction and there may be a plurality of gaps between the elongate vapour generating components. As noted above, the gaps facilitate the flow of air and vapour through the vapour generating article and may facilitate the insertion of a heater into the vapour generating article.

The plurality of elongate vapour generating components may be positioned in a tubular member having a longitudinal axis and the elongate vapour generating components may be substantially oriented in the direction of the longitudinal axis. The tubular member may typically comprise a material which is electrically insulating and non-magnetic, for example paper or a plastics material. The tubular member may, for example, comprise a paper wrapper. The vapour generating article is easy to manufacture due to its tubular shape. The shape may also facilitate storage/packaging of multiple vapour generating articles, handling of the article by a user, and insertion of the article into a heating device.

The ends of the vapour generating components and the tubular member may be substantially aligned in the longitudinal direction. Such an arrangement may facilitate manufacture of vapour generating articles and may optimise air flow through the vapour generating article since the air only comes from the edge of the band of vapour generating components and goes out from the opposite edge of the band.

The elongate vapour generating components and the tubular member may be substantially the same length. Such an arrangement ensures that there is a uniform distribution of the vapour generating components within the tubular member in the longitudinal direction, thereby ensuring that a uniform air flow and uniform heating (since the density of elongate vapour generating components is uniform in the longitudinal direction) through the vapour generating article is achieved. In addition, this configuration prevents the vapour generating components from dropping out of the tubular member.

The vapour generating article may have a diameter between 4.0 mm and 10.0 mm. The diameter may be between 5.0 mm and 9.0 mm and may possibly be between 6.0 mm and 7.5 mm.

The elongate vapour generating components may have a cross-sectional area with a maximum dimension (e.g. diameter) between 0.1 mm and 1.5 mm, preferably between 0.3 mm and 1.2 mm, and more preferably between 0.5 mm and 1.0 mm. As noted above, manufacture of the vapour generating article is simplified because the elongate vapour generating components have a much smaller cross-sectional area than the cross-sectional area of the vapour generating article.

At least one of the vapour generating components may have a cross-sectional area which is circular, rectangular, triangular, polygonal or comprises a plurality of lobes. Elongate vapour generating components with a circular cross-section or comprising a plurality of lobes may be easier to extrude and may facilitate the insertion of a heater into the vapour generating article. Elongate vapour generating components with a circular cross-section can also be easily wound onto, and subsequently unwound from, a bobbin thereby facilitating manufacture of vapour generating articles. For these reasons, elongate vapour generating components with a circular cross-section may be preferred.

Elongate vapour generating components with a rectangular or triangular cross-section or comprising a plurality of lobes have a high surface-to-volume ratio, that is a high surface area for vapour generation can be achieved with a low mass of vapour generating material.

The heating device of the vapour generating system may comprise a heater extending in a heating chamber towards an opening through which the vapour generating article is inserted. With this arrangement, the heater is inserted into a vapour generating substrate formed by the vapour generating components during insertion of the vapour generating article into the heating chamber through the opening.

The heater may comprise a needle-shaped heater. A needle-shaped heater has an optimal shape, even compared to a blade shape, for insertion into the vapour generating substrate formed by the vapour generating components, because the needle-shaped heater can be easily received in the gaps formed between the vapour generating components.

The heating device may comprise at least two of said heaters. The use of multiple heaters provides more uniform and effective heating of the elongate vapour generating components because the heaters are at different positions within the vapour generating substrate.

The direction in which the or each heater extends may be substantially parallel to a direction in which the vapour generating components are oriented. Insertion of the heater(s) into gaps formed between the vapour generating components is thereby facilitated.

The vapour generating article may include an inductively heatable susceptor and the heating device may include an electromagnetic field generator. The vapour generating article may include an inductively heatable susceptor positioned in the vapour generating substrate. Thus, vapour generation can be achieved by inductive heating of the inductively heatable susceptor.

The inductively heatable susceptor may include a part which extends substantially in the direction in which the elongate vapour generating components are aligned. Such an arrangement may help to ensure that the inductively heatable susceptor is correctly aligned with respect to the electromagnetic field generator and, therefore, that the inductively heatable susceptor is optimally coupled with an electromagnetic field generated by the electromagnetic field generator. Such an arrangement may also maximise heat transfer from the inductively heatable susceptor to the elongate vapour generating components. Furthermore, by orienting the inductively heatable susceptor substantially in the direction in which the elongate vapour generating components are aligned, manufacture of the vapour generating article may be facilitated.

The inductively heatable susceptor may be strip-shaped or plate-shaped, may be stick-shaped, may be U-shaped, may be E-shaped, may be I-shaped, may be pin-shaped or may be tubular, for example with a circular, rectangular or square cross-section.

The inductively heatable susceptor may comprise one or more, but not limited, of aluminium, iron, nickel, stainless steel and alloys thereof, e.g. Nickel Chromium or Nickel Copper. With the application of an electromagnetic field in its vicinity, the susceptor may generate heat due to eddy currents and magnetic hysteresis losses resulting in a conversion of energy from electromagnetic to heat.

The electromagnetic field generator may comprise an induction coil. The induction coil may comprise a Litz wire or a Litz cable. It will, however, be understood that other materials could be used.

The electromagnetic field generator, e.g. the induction coil, may be arranged to operate in use with a fluctuating electromagnetic field having a magnetic flux density of between approximately 20 mT and approximately 2.0 T at the point of highest concentration.

The heating device may include a power source and circuitry which may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

### BRIEF DESCRIPTION OF THE DRAWINGS

FIG. 1 is a diagrammatic perspective view of a first embodiment of a vapour generating system comprising a first example of a heating device and first example of a vapour generating article;

FIG. 1a is a diagrammatic cross-sectional side view of the first example of the vapour generating article shown in FIG. 1;

FIG. 2 is a diagrammatic perspective view of a second embodiment of a vapour generating system comprising a second example of a heating device and second example of a vapour generating article;

FIG. 2a is a diagrammatic cross-sectional side view of the second example of the vapour generating article shown in FIG. 2;

FIGS. 3 to 5 and 3a to 5a are respectively diagrammatic perspective and diagrammatic cross-sectional side views of further examples of vapour generating articles suitable for use with the second example of the heating device illustrated in FIG. 2;

FIGS. 6a to 6f are diagrammatic views showing example cross-sectional shapes of a vapour generating component; and

FIG. 7 is a flowchart illustrating the steps of one example of a method for manufacturing a vapour generating article.

### DETAILED DESCRIPTION OF EMBODIMENTS

Embodiments of the present disclosure will now be described by way of example only and with reference to the accompanying drawings.

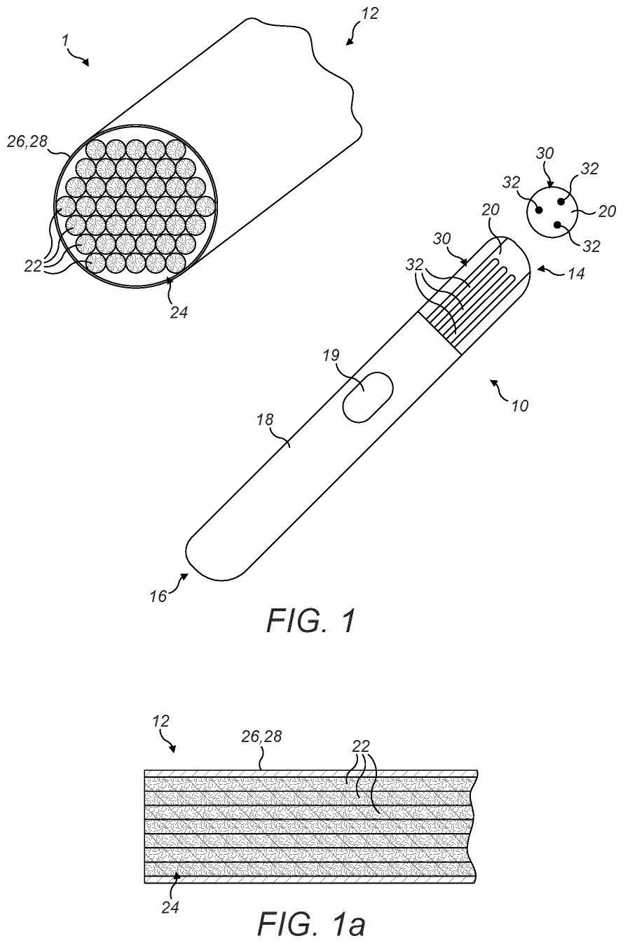

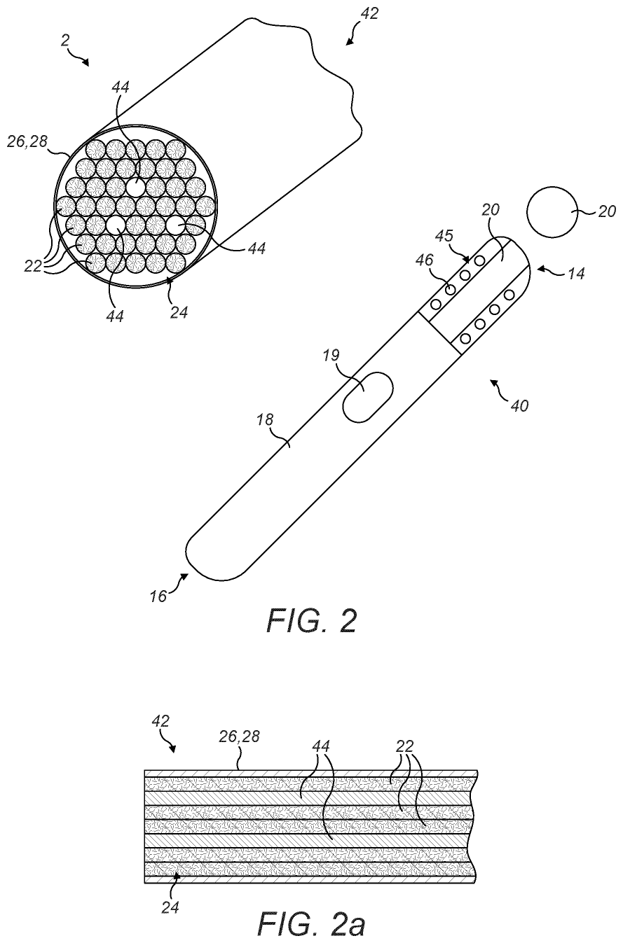

Referring initially to FIGS. 1 and 1a, there is shown diagrammatically a perspective view of a first embodiment of a vapour generating system 1. The vapour generating system 1 comprises a first example of a heating device 10 and a first example of a vapour generating article 12. The dimensions of the vapour generating article 12 are exaggerated relative to the dimensions of the heating device 10 for the purposes of illustration and only part of the vapour generating article 12 is shown in FIG. 1.

The heating device 10 has a first end 14 and a second end 16 and comprises a device body 18 which includes a power source and a controller. The power source typically comprises one or more batteries which could, for example, be inductively rechargeable. The heating device 10 further includes a button 19 which can be pressed by a user to control the operation of the heating device 10.

The heating device 10 is generally cylindrical and comprises a generally cylindrical heating chamber 20 formed in the device body 18 at the first end 14 of the heating device 10. The heating chamber 20 is arranged to receive a correspondingly shaped generally cylindrical vapour generating article 12.

The vapour generating article 12 comprises a plurality of extruded elongate vapour generating components 22 which are all substantially aligned with each other and which together form a vapour generating substrate 24. The vapour generating components 22 are solid (i.e. are not hollow) and typically comprise plant derived material, such as tobacco, and may comprise reconstituted tobacco including tobacco and any one or more of cellulose fibres, tobacco stalk fibres and inorganic fillers such as CaCO3.

The vapour generating components 22 comprise an aerosol-former such as glycerine or propylene glycol. Typically, the vapour generating components 22 comprise an aerosol-former content of between approximately 5% and approximately 50% on a dry weight basis. Upon heating, the vapour generating components 22 release volatile compounds possibly including nicotine or flavour compounds such as tobacco flavouring.

The vapour generating components 22 are positioned in a tubular member 26 and are oriented substantially in line with a longitudinal axis of the tubular member 26. The tubular member 26 comprises a material which is substantially non-electrically conductive and non-magnetically permeable and, in the illustrated example, comprises a paper wrapper 28.

The vapour generating substrate 24 typically comprises between 5 and 100 of the vapour generating components 22 and a plurality of gaps is present between the vapour generating components 22.

The heating device 10 comprises a resistive heater 30, for example comprising a plurality of needle-shaped heating elements 32, which extend into the heating chamber 20 from the device body 18 as can be clearly seen in the perspective view and the view from the open end of the heating chamber 20 in FIG. 1. The heating elements 32 are arranged in the heating chamber 20 so that they are inserted into the vapour generating substrate 24 when a vapour generating article 12 is positioned in the heating chamber 20. The heating elements 32 extend in a direction substantially parallel to the direction in which the vapour generating components 22 are oriented and the heating elements 32 may advantageously extend into the gaps between the vapour generating components 22, thereby facilitating insertion of the vapour generating article 12 into the heating chamber 20 whilst at the same time minimising or avoiding deformation of the vapour generating components 22.

During operation of the vapour generating system 1, for example when activated by a user press of the button 19, an electric current is supplied to the heating elements 32 causing them to heat up. The heat from the heating elements 32 is transferred to the vapour generating components 22 of a vapour generating article 12 positioned in the heating chamber 20, for example by conduction, radiation and convection, thereby heating the vapour generating components 22 and producing a vapour which can be inhaled by a user of the vapour generating system 1.

Although not visible in FIG. 1, either the heating device 10 or the vapour generating article 12 includes a mouthpiece through which the vapour is inhaled by a user. In embodiments in which the vapour generating article 12 includes a mouthpiece, the mouthpiece may typically comprise a filter, for example comprising cellulose acetate fibres.

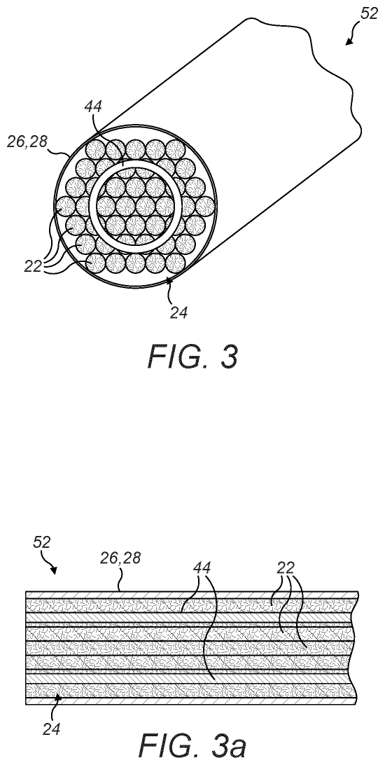

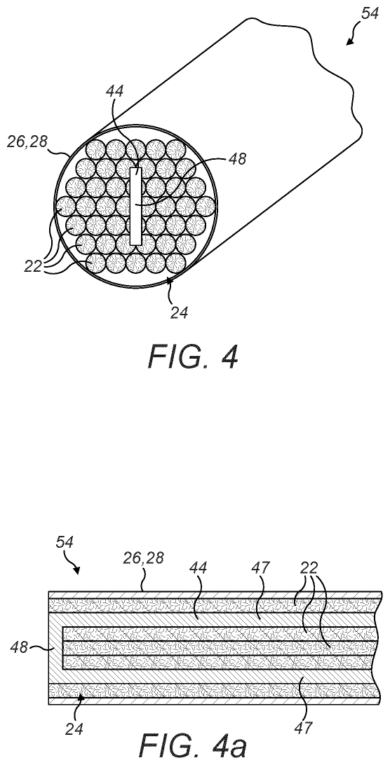

Referring now to FIGS. 2 and 2a, there is shown a second embodiment of a vapour generating system 2. The vapour generating system 2 has some features in common with the vapour generating system 1 described above with reference to FIG. 1 and corresponding elements are designated using the same reference numerals.

The vapour generating system 2 comprises a second example of a heating device 40 and a second example of a vapour generating article 42.

The vapour generating article 42 is similar to the vapour generating article 12, with the only difference being that it comprises a plurality of inductively heatable susceptors 44 positioned in the vapour generating substrate 24. The inductively heatable susceptors 44 are substantially I-shaped or pin-shaped and extend in substantially the same direction as the elongate vapour generating components 22.

The heating device 40 includes an electromagnetic field generator 45 which is configured to operate at high frequency. The electromagnetic field generator 45 includes a helical induction coil 46 which has a circular cross-section and which extends around the heating chamber 20. The induction coil 46 is visible in the perspective view of the heating device 40 in FIG. 2 but is not shown in the view from the open end of the heating chamber 20. The induction coil 46 can be energised by the power source and controller. The controller includes, amongst other electronic components, an inverter which is arranged to convert a direct current from the power source into an alternating high-frequency current for the induction coil 46.

As will be understood by one of ordinary skill in the art, when the induction coil 46 is energised, for example due to activation of the heating device 40 by a user press of the button 19, an alternating electromagnetic field is produced. This couples with the induction heatable susceptors 44 of a vapour generating article 42 positioned in the heating chamber 20 and generates eddy currents and/or magnetic hysteresis losses in the induction heatable susceptors 44 causing them to heat up. The heat is then transferred from the induction heatable susceptors 44 to the vapour generating components 22, for example by conduction, radiation and convection.

The induction heatable susceptors 44 can be in direct or indirect contact with the vapour generating components 22 such that, when the susceptors 44 are inductively heated by the induction coil 46, heat is transferred from the susceptors 44 to the vapour generating components 22, to heat the vapour generating components 22 and thereby produce a vapour which can be inhaled by a user of the vapour generating system 2 through a mouthpiece associated with the heating device 40 or the vapour generating article 42.

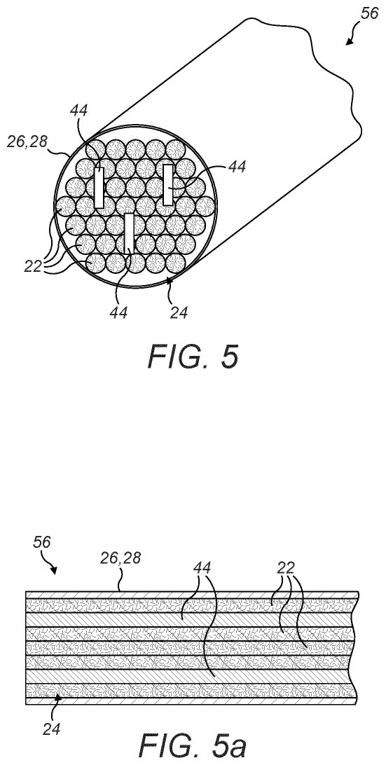

Referring now to FIGS. 3 and 3a, there is shown a third example of a vapour generating article 52 which is similar to the vapour generating article 42 illustrated in FIGS. 2 and 2a and in which corresponding elements are designated using the same reference numerals. The vapour generating article 52 can be used with the heating device 40.

The vapour generating article 52 is identical to the vapour generating article 42 illustrated in FIGS. 2 and 2a in all respects except that the inductively heatable susceptor 44 is tubular. The vapour generating components 22 are positioned both inside and outside of the tubular inductively heatable susceptor 44 to maximise heat transfer to the vapour generating components 22 and to thereby maximise the amount of aerosol that is generated whilst at the same time maximising energy efficiency.

In preferred embodiments, the tubular inductively heatable susceptor 44 and the tubular paper wrapper 28 are concentric, thereby ensuring that the vapour generating components 22 are uniformly heated.

Referring now to FIGS. 4 and 4a, there is shown a fourth example of a vapour generating article 54 which is similar to the vapour generating article 42 illustrated in FIGS. 2 and 2a and in which corresponding elements are designated using the same reference numerals. The vapour generating article 54 can be used with the heating device 40.

The vapour generating article 54 is identical to the vapour generating article 42 illustrated in FIGS. 2 and 2a in all respects except that the inductively heatable susceptor 44 is substantially U-shaped, comprising two elongate parts 47 which extend fully or partially through the vapour generating substrate 24 and a connecting part 48 positioned at an and of the vapour generating article 54 which connects the elongate parts 47.

Referring now to FIGS. 5 and 5a, there is shown a fifth example of a vapour generating article 56 which is similar to the vapour generating article 42 illustrated in FIGS. 2 and 2a and in which corresponding elements are designated using the same reference numerals. The vapour generating article 56 can be used with the heating device 40.

The vapour generating article 56 is identical to the vapour generating article 42 illustrated in FIGS. 2 and 2a in all respects except that the inductively heatable susceptors 44 are substantially strip-shaped or plate-shaped.

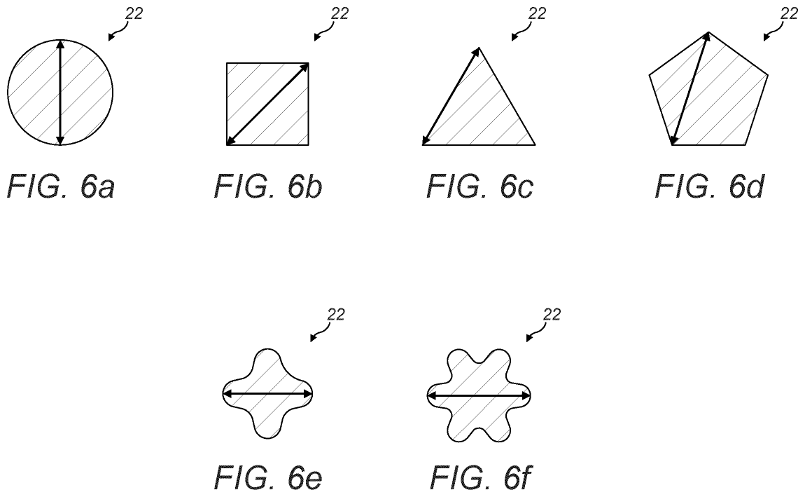

In all of the examples described above, the vapour generating components 22 have a substantially circular cross-sectional shape, as shown in FIG. 6a. The vapour generating components 22 may, however, have any suitable cross-sectional shape, including rectangular or square as shown in FIG. 6b, triangular as shown in FIG. 6c, polygonal as shown in FIG. 6d or comprising a plurality of lobes as shown in FIGS. 6e and 6f. Irrespective of the cross-sectional shape, it may be preferred that the cross-sectional area of the vapour generating components 22 has a maximum dimension (denoted by the arrow in FIGS. 6a to 6f) of between 0.5 mm and 1.0 mm in the case where the vapour generating article 12, 42, 52, 54, 56 has a diameter between 4.0 mm and 10.0 mm.

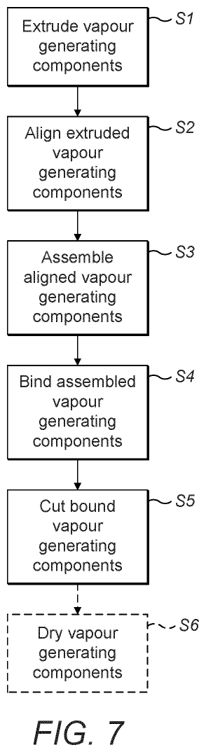

Referring now to the flowchart illustrated in FIG. 7, the vapour generating articles 12, 42, 52, 54, 56 can be manufactured by extruding in step S1 a plurality of elongate vapour generating components 22 through an aperture having a cross-sectional area with a maximum dimension between 0.5 mm and 1.0 mm, to provide extruded elongate vapour generating components 22 having a corresponding cross-sectional area and maximum dimension. The vapour generating components 22 can be extruded in parallel to simultaneously align them (i.e. steps S1 and S2 are performed simultaneously), or alternatively the alignment of the vapour generating components 22 can be carried out separately, after the vapour generating components 22 have been extruded (i.e. step S2 is performed after step S1).

The aligned vapour generating components 22 are assembled in step S3 to form a band before the band of aligned vapour generating components 22 is bound in step S4. Typically, the band of aligned vapour generating components 22 is bound in step S4 by wrapping the band of aligned vapour generating components 22 with a paper wrapper 28. The bound band of assembled vapour generating components 22 can then be cut in step S5 at appropriate positions along its length to form a plurality of individual vapour generating articles.

The manufacturing process further comprises drying in step S6 the vapour generating components 22. The drying step can be performed at any suitable point in the manufacturing process, as denoted by the dashed lines in FIG. 7. For example, the extruded vapour generating components 22 could be dried (i.e. step S6 could be performed) immediately after they have been extruded in step S1 or at a later point in the process.

In some instances, it may be advantageous to bobbinize the extruded vapour generating components 22 by winding them onto individual bobbins. In such instances, the drying step (step S6) is performed immediately after extruding the vapour generating components 22 in step S1. After the drying step (step S6) has been performed, each of the vapour generating components 22 can be wound onto an individual bobbin. The vapour generating components 22 can then be unwound from the individual bobbins and, in the manner described above, the vapour generating components 22 can then be aligned in step S2, assembled to form a band in step S3, bound in step S4 and finally cut in step S5 to form a plurality of individual vapour generating articles.

In examples in which the vapour generating article comprises one or more inductively heatable susceptors 44, for example as described above with reference to FIGS. 2 to 5, the inductively heatable susceptor(s) 44 is/are inserted into the vapour generating substrate 24 formed by the elongate vapour generating components 22 at an appropriate point during the manufacturing process.

In one implementation, one or more inductively heatable susceptors 44 is/are inserted into the plurality of bound vapour generating components 22 after they have been bound in step S4 to form a band by wrapping with a paper wrapper 28, and the bound band is cut in step S5 to form individual vapour generating articles.

In another implementation, one or more inductively heatable susceptors 44 having an elongate part is/are positioned between the extruded vapour generating components 22 during the step of aligning (step S2) the extruded vapour generating components 22, with the elongate part of the one or more inductively heatable susceptors 44 aligned with the vapour generating components 22. In this implementation, the aligned vapour generating components 22 and inductively heatable susceptor(s) 44 are assembled to form a band in step S3 before the band is bound in step S4 by wrapping with a paper wrapper 28 and thereafter cut in step S5 at appropriate positions to form individual vapour generating articles.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A method for manufacturing a vapour generating article, the method comprising:
(i) extruding a plurality of elongate vapour generating components;
(ii) aligning the plurality of extruded vapour generating components;
(iii) assembling the plurality of aligned vapour generating components to form a band;
(iv) binding the band of assembled vapour generating components;
(v) cutting the bound band of assembled vapour generating components to form the vapour generating article;
(vi) after step (i), drying the plurality of vapour generating components.

2. The method according to claim 1, wherein steps (i) and (ii) comprise extruding a plurality of elongate vapour generating components in parallel to thereby simultaneously align the elongate vapour generating components.

3. The method according to claim 1, wherein the method further comprises after steps (i) and (vi) and prior to step (ii):
(vii) winding one of the dried elongate vapour generating components on a bobbin; and
(viii) unwinding the dried elongate vapour generating component from the bobbin.

4. The method according to claim 1, wherein the method further comprises after step (iv), and preferably after step (v), inserting an inductively heatable susceptor into the plurality of bound vapour generating components.

5. The method according to claim 1, wherein step (ii) further comprises positioning an inductively heatable susceptor having an elongate part between the plurality of elongate vapour generating components, and preferably with the elongate part in alignment with the elongate vapour generating components.

6. The method according to claim 5, wherein step (iii) comprises assembling the plurality of aligned vapour generating components and the inductively heatable susceptor to form a band and step (iv) comprises binding the band of assembled vapour generating components and the inductively heatable susceptor.

7. A vapour generating system comprising:
a vapour generating article comprising at least five extruded elongate vapour generating components; and
a heating device for heating the vapour generating article;
wherein the vapour generating article or the heating device includes a mouthpiece.

8. The vapour generating system according to claim 7, wherein the heating device comprises a heater extending in a heating chamber towards an opening through which the vapour generating article is inserted.

9. The vapour generating system according to claim 8, wherein the heater comprises a needle-shaped heater.

10. The vapour generating system according to claim 8, wherein the heating device comprises at least two of said heaters.

11. The vapour generating system according to claim 8, wherein the direction in which the heater extends is substantially parallel to a direction in which the vapour generating components are oriented.

12. The vapour generating system according to claim 7, wherein the vapour generating article includes an inductively heatable susceptor and the heating device includes an electromagnetic field generator.

13. A vapour generating article comprising:
at least five extruded elongate vapour generating components that form a vapour generating substrate; and
a mouthpiece.

14. The vapour generating article according to claim 13, further comprising an inductively heatable susceptor positioned in the vapour generating substrate.

15. The vapour generating article according to claim 14, wherein the inductively heatable susceptor comprises at least one of stick-shaped susceptors, a tubular susceptor, strip-shaped or plate-shaped susceptors.

16. The vapour generating article according to claim 13, wherein the extruded elongate vapour generating components comprise solid vapour generating components.
